(19) United States
(12) Patent Application Publication
(10) Pub. No.: US 2026/0112709 A1
(43) Pub. Date: Apr. 23, 2026

(54) SEPARATOR, PREPARATION METHOD THEREOF AND ELECTROCHEMICAL DEVICE INCLUDING THE SAME

(71) Applicant: LG ENERGY SOLUTION, LTD., Seoul (KR)

(72) Inventors: Won-Sik BAE, Daejeon (KR); Byeong-Chan BAK, Daejeon (KR); Kyeong-Hui BAE, Daejeon (KR); Dong-Wook SUNG, Daejeon (KR); So-Yeong LEE, Daejeon (KR); In-Young CHOI, Daejeon (KR)

(21) Appl. No.: 19/337,487

(22) Filed: Sep. 23, 2025

(30) Foreign Application Priority Data
Oct. 10, 2024 (KR) 10-2024-0138017

(51) Int. Cl. H01M 10/42; H01M 50/406; H01M 50/417; H01M 50/489

(52) U.S. Cl. CPC H01M 10/4235; H01M 50/406; H01M 50/417; H01M 50/489

(57) ABSTRACT

A separator according to an aspect of the present disclosure includes a polyolefin-based substrate having a thickness of about 8 μm or less. The polyolefin-based substrate has a minimum pore size of about 20 nm or more.

### CROSS-REFERENCE TO RELATED APPLICATIONS

This application is based on and claims priority from Korean Patent Application No. 10-2024-0138017 filed on Oct. 10, 2024, with the Korean Intellectual Property Office, the disclosure of which is incorporated herein in its entirety by reference.

### TECHNICAL FIELD

The present disclosure relates to a separator, a method of manufacturing the same, an electrode assembly, and an electrochemical device including the same.

### BACKGROUND

A lithium secondary battery is manufactured through a process of inserting an electrode assembly, which is a unit of a positive electrode/separator/negative electrode, into a battery case, injecting an electrolyte, and sealing the case. The separator functions to prevent or suppress direct physical contact between the positive electrode and the negative electrode. As a separator for use in a lithium secondary battery, for example, a polyolefin-based porous substrate has been used.

Recently, research efforts have been continuously conducted to reduce the weight of battery materials in order to achieve high energy density of lithium secondary batteries. Research has also been conducted to implement a thin-film separator for weight reduction while still using the conventional polyolefin-based porous substrate.

### SUMMARY

The present disclosure provides a separator, and an electrode assembly and an electrochemical device including the separator.

The present disclosure provides a thin-film separator as one of the components of a battery in order to reduce the weight of an electrochemical device, for example, a lithium secondary battery.

The present disclosure provides a separator that is thin and yet achieves low electrical resistance and suppresses lithium plating caused by charge/discharge cycles, thereby improving the lifespan of an electrochemical device, a method of manufacturing the separator, an electrode assembly to which the separator is applied, and an electrochemical device including the electrode assembly.

According to an aspect of the present disclosure, separators of the following embodiments are provided.

In a first embodiment, the separator includes a polyolefin-based substrate having a thickness of about 8 μm or less, and the polyolefin-based substrate has a minimum pore size of about 20 nm or more.

According to a second embodiment, in the first embodiment, the minimum pore size may be measured by a method of measuring the pore size when the water saturation degree is 99 vol % based on 100 vol % water saturation when water is infiltrated into the polyolefin-based substrate under a constant pressure.

According to a third embodiment, in the first embodiment or the second embodiment, the polyolefin-based substrate may have a thickness of about 5 μm to about 8 μm.

According to a fourth embodiment, in any one of the first to third embodiments, the minimum pore size of the polyolefin-based substrate may be about 20 nm to about 30 nm.

According to a fifth embodiment, in any one of the first to fourth embodiments, the electrical resistance of the separator may be about 0.40Ω or less.

According to a sixth embodiment, in any one of the first to fifth embodiments, the separator may further include at least one layer selected from a heat-resistant coating layer and a binder adhesive layer on at least one surface of the polyolefin-based substrate.

According to another aspect of the present disclosure, methods of manufacturing separators of the following embodiments are provided.

According to a seventh embodiment, a method for manufacturing a separator includes the steps of: extruding, cooling, and molding a polyolefin resin raw material to obtain a polymer sheet; stretching the obtained polymer sheet in MD and TD; and heat-setting the stretched polymer sheet to obtain a polyolefin-based substrate, in which at least one of the MD stretching and the TD stretching is performed at a temperature of about 130° C. to about 145° C., and the polyolefin-based substrate has a thickness of about 8 μm or less.

According to an eighth embodiment, in the seventh embodiment, the stretching step includes stretching in the MD direction followed by stretching in the TD direction, wherein the MD stretching may be performed at a temperature of about 110° C. to about 125° C., and the TD stretching may be performed at a temperature of about 130° C. to about 140° C.

According to a ninth embodiment, in the seventh or eighth embodiment, the TD stretching may be performed at a stretching ratio of 8 to 10 times.

According to a tenth embodiment, in any one of the seventh to ninth embodiments, the minimum pore size of the polyolefin-based substrate may be about 20 nm or more.

According to another aspect of the present disclosure, electrode assemblies and electrochemical devices of the following embodiments are provided.

According to an eleventh embodiment, an electrode assembly may include a separator according to any one of the first to sixth embodiments, and a positive electrode and a negative electrode provided on respective opposite surfaces of the separator.

According to a twelfth embodiment, an electrochemical device may include the electrode assembly according to the eleventh embodiment, and a case accommodating the electrode assembly.

According to a thirteenth embodiment, in the twelfth embodiment, the electrochemical device may exhibit a capacity retention of 90% or more according to Equation 1 below.

Capacity Retention (%)=(Cₙ₊₂₀₀/Cₙ)×100(%) (where n is an integer of 1 or more) [Equation 1]

According to a fourteenth embodiment, in the seventh embodiment, the method may further include the step of removing the diluent after the step of stretching in the MD and TD.

According to a fifteenth embodiment, in the fourteenth embodiment, the amount of the diluent remaining in the polymer sheet after the extraction of the diluent may be about 1 wt % or less based on the total weight of the polymer sheet.

A separator according to an embodiment of the present disclosure may include a polyolefin-based substrate having a thickness of about 8 μm or less.

A separator according to an embodiment of the present disclosure may be thin and yet may secure safety without being damaged even after lamination with an electrode. The separator according to an embodiment of the present disclosure may exhibit a low electrical resistance value by controlling the size of fine pores.

Furthermore, an electrochemical device to which the separator according to an embodiment of the present disclosure is applied may exhibit an advantage in that lithium plating caused by charge/discharge cycles is suppressed, thereby improving lifespan.

As a result, the electrochemical device using the separator may exhibit not only high energy density due to weight reduction, but also excellent lifespan.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a flowchart illustrating a method of manufacturing a separator according to an embodiment of the present disclosure.

FIG. 2 is a graph illustrating a relationship between pore size and cumulative pore volume of a polyolefin-based substrate according to an embodiment of the present disclosure.

### DETAILED DESCRIPTION

Herein, when a part is referred to as “including” a component, this means that, unless specifically stated otherwise, the part does not exclude other components but may further include other components.

As used herein, the term “A and/or B” means “A or B, or both of them.”

Specific terms used in the following detailed description of the invention are for convenience only and are not intended to limit the present disclosure. For example, words indicating directions such as “upper” and “lower” are terms used illustratively to describe positional relationships with respect to a reference point, and are not intended to limit absolute positional relationships.

As used herein, the terms “about,” “approximately,” and “substantially” are used to mean a range of the numerical value or degree, or a value close thereto, in consideration of inherent manufacturing and material tolerances (e.g., ±5%).

As separators have become thinner, problems have occurred in which the inherent function of the separators deteriorates due to factors such as compression of the separators when laminating the positive electrode/separator/negative electrodes during the manufacturing of electrode assemblies, and damage to the separators caused by heating and pressurization during an adhesion process such as hot pressing. In addition, as the charge/discharge cycles of the electrochemical device are repeated, lithium plating occurs in the fine pores of the thin-film separators, resulting in a significant reduction in the lifespan of the electrochemical device.

Accordingly, in electrochemical devices such as lithium secondary batteries, there is an increasing demand for achieving both safety and high performance.

Therefore, the development of a separator capable of performing the inherent functions of a separator while also improving the lifespan of an electrochemical device is still required.

In consideration of this, the present disclosure provides a separator that is thin and yet achieves low electrical resistance and suppresses lithium plating caused by charge/discharge cycles, thereby improving the lifespan of an electrochemical device, a method of manufacturing the separator, an electrode assembly to which the separator is applied, and an electrochemical device including the electrode assembly.

### Separator

According to an aspect of the present disclosure, a separator including a polyolefin-based substrate is provided.

For example, a separator according to an aspect of the present disclosure includes a polyolefin-based substrate having a thickness of about 8 μm or less.

In addition, a separator according to an aspect of the present disclosure includes a polyolefin-based substrate having a minimum pore size of about 20 nm or more.

Alternatively, a separator according to an aspect of the present disclosure includes a polyolefin-based substrate having a thickness of about 8 μm or less, and the polyolefin-based substrate has a minimum pore size of about 20 nm or more.

The polyolefin-based substrate used as a separator substrate includes a plurality of pores on a surface and/or in the inside thereof. Through the plurality of pores, even when the separator is interposed between a positive electrode and a negative electrode, charge transfer and lithium-ion transport between the positive electrode and the negative electrode are possible. However, when the thickness of the polyolefin-based substrate is small, for example, 8 μm or less, when the pore size becomes too small, lithium ions moving through the pores may receive electrons and become trapped inside the pores of the separator, which may cause a problem of deteriorating the air permeability of the separator.

In order to prevent or suppress such a problem, a separator substrate according to an aspect of the present disclosure has a minimum pore size of about 20 nm or more.

As used herein, the “minimum pore size” refers to a value measured by a water intrusion method. For example, when water is infiltrated into the polyolefin-based separator substrate under a predetermined pressure, a graph of cumulative pore volume (vol %) according to pore size (nm) may be obtained. At this time, when a point where the pore volume is 100 vol % is defined as a state in which the water saturation degree is 100 vol %, and a point where the pore volume is 1 vol % is defined as a state in which the water saturation degree is 1 vol %, the minimum pore size refers to a pore size (nm) value at the time when the water saturation degree is 99 vol % based on 100 vol % of water saturation.

According to an embodiment of the present disclosure, when performing the water intrusion method, water may be injected in a pressure range of, for example, about 150 psi to about 1,800 psi, but the present disclosure is not limited thereto.

According to an embodiment of the present disclosure, the minimum pore size of the polyolefin-based substrate may be about 20 nm or more, for example, about 20 nm to about 50 nm, about 20 nm to about 40 nm, about 20 nm to about 30 nm, about 20 nm to about 25 nm, or about 22 nm to about 24 nm, but the present disclosure is not limited thereto. When the minimum pore size of the polyolefin-based substrate is within the above range, advantageous effects may be exhibited in terms of lowering the resistance of the separator. In addition, when the minimum pore size of the polyolefin-based substrate is within the above range, advantageous effects may also be exhibited in terms of the insulating properties of the separator, but the present disclosure is not limited thereto. In an embodiment of the present disclosure, the insulating properties of the separator may be compared by measuring the breakdown voltage of the separator according to an embodiment of the present disclosure, but the present disclosure is not limited thereto.

According to an embodiment of the present disclosure, the thickness of the polyolefin-based substrate is not particularly limited as long as it is about 8 μm or less. According to an embodiment, in terms of mechanical strength of the separator, for example, the thickness may be about 3 μm to about 8 μm, about 4 μm to about 8 μm, about 5 μm to about 8 μm, about 6 μm to about 7 μm, about 6.5 μm to about 7.5 μm, or about 7.0 μm, but the present disclosure is not limited thereto. When the thickness of the polyolefin-based substrate is within the above range, an advantageous effect may be exhibited in reducing the resistance of the separator and improving the performance of an electrochemical device using the separator, but the present disclosure is not limited thereto.

As used herein, the “thickness” of the polyolefin-based substrate may be measured by a known method of measuring each thickness of components of an electrochemical device. For example, the thickness of the polyolefin-based substrate may be measured using a known thickness gauge, and may be measured using, for example, a commercially available thickness gauge (Mitutoyo Co., VL-50S-B, tip diameter: 9.5 mm, spherical radius: 10 mm).

In an embodiment of the present disclosure, the polyolefin-based substrate may be manufactured by using a polyolefin-based material as a thermoplastic resin in order to perform an ion-conductive barrier function of blocking contact between a positive electrode and a negative electrode while allowing ions to pass therethrough for the inherent function of the separator, and also to perform a shutdown function.

In an embodiment of the present disclosure, the polyolefin-based substrate refers to a substrate including a material formed by polymerization of an olefin, and is not particularly limited as long as a conventional material used for separators is used as the olefin. For example, the olefin may include polyethylene, polypropylene, or a mixture thereof.

According to an embodiment of the present disclosure, the separator may include a polyolefin-based substrate manufactured by a wet process as described below. The polyolefin-based substrate may generally be manufactured by either a wet method or a dry method. In this case, the polyolefin-based substrate may be manufactured by the wet process in terms of implementing the polyolefin-based substrate in a thin-film form and increasing the uniformity of pore size.

According to an embodiment of the present disclosure, the separator may further include a binder adhesive layer including a binder polymer on at least one surface of the polyolefin-based substrate to improve adhesion to an electrode.

In another embodiment of the present disclosure, the separator may further include a heat-resistant coating layer formed on at least one surface of the polyolefin-based substrate and including inorganic particles and a binder polymer to enhance heat resistance.

In still another embodiment of the present disclosure, the separator may further include a heat-resistant coating layer and/or a binder adhesive layer on at least one surface of the polyolefin-based substrate, but the present disclosure is not limited thereto.

According to an embodiment of the present disclosure, the separator may not include a heat-resistant coating layer including inorganic particles and a binder polymer, and may use only the polyolefin-based substrate. For example, the separator may include only the polyolefin-based substrate.

According to another embodiment of the present disclosure, the separator may include only the polyolefin-based substrate and a binder adhesive layer.

According to still another embodiment of the present disclosure, the separator may include the polyolefin-based substrate, a heat-resistant coating layer formed on at least one surface of the polyolefin-based substrate, and a binder adhesive layer formed on one surface of the heat-resistant coating layer. Here, the “one surface of the heat-resistant coating layer” refers to a surface that faces an electrode when the separator is bonded to the electrode.

In an embodiment of the present disclosure, the binder polymer that may be used in the binder adhesive layer and/or the heat-resistant coating layer is not particularly limited as long as it is a material that can be used in a separator to exhibit adhesion. For example, the binder polymer may include a polyvinylidene fluoride (PVdF)-based resin, an acrylic resin, a rubber-based resin, or a mixture of two or more thereof, but the present disclosure is not limited thereto.

In an embodiment of the present disclosure, the inorganic particles that may be used in the heat-resistant coating layer are not particularly limited as long as they are electrochemically stable. For example, the inorganic particles are not particularly limited as long as they do not undergo oxidation and/or reduction reactions within the operating voltage range (e.g., 0 to 5 V based on Li/Li⁺) of an electrochemical device to which the separator is applied. For example, the inorganic particles may include BaTiO₃, Pb(Zr,Ti)O₃ (PZT), Pb₁₋ₓLaₓZr_{i-y}Ti_{y}O₃(PLZT, 0<x<1, 0<y<1), Pb(Mg_{1/3}Nb_{2/3})O₃—PbTiO₃ (PMN−PT), hafnia (HfO₂), SrTiO₃, SnO₂, CeO₂, MgO, NiO, CaO, ZnO, ZrO₂, SiO₂, Y₂O₃, Al₂O₃, SiC, and TiO₂, and may include one or more thereof, but the present disclosure is not limited thereto.

In an embodiment of the present disclosure, when the separator further includes the heat-resistant coating layer, in order to prevent pores of the separator from being blocked by the inorganic particles and thereby preventing a decrease in porosity of the separator, the average particle diameter (D50) of the inorganic particles may be about 100 nm or more. For example, the average particle diameter (D50) of the inorganic particles may be about 100 nm to about 1 μm, or about 100 nm to about 500 nm, but the present disclosure is not limited thereto.

Herein, the particle diameter of the inorganic particles may be measured by a known particle size measuring method, and may be measured using, for example, a particle size analyzer (PSA) commercially available from Malvern Co. In addition, the average particle diameter (D50) refers to a particle diameter at a 50% point of a cumulative volume distribution according to particle diameter, and may be measured by a known laser diffraction method. In this case, the laser diffraction particle size measuring apparatus may be, for example, Microtrac S3500 commercially available from Microtrac Co.

In an embodiment of the present disclosure, the thickness of the binder adhesive layer and/or the heat-resistant coating layer is not particularly limited as long as it does not impair the objective of the present disclosure of thinning the separator. For example, the thickness of the binder adhesive layer and/or the heat-resistant coating layer may be about 0.5 μm to about 20 μm, about 0.5 μm to about 10 μm, about 0.5 μm to about 5 μm, or about 1.5 μm to about 3 μm, but the present disclosure is not limited thereto.

A separator according to an embodiment of the present disclosure may include a polyolefin-based substrate, thereby having insulating properties, but may be used in an electrochemical device as it has a porous form. For example, the separator may have significantly different electrical resistance values depending on the characteristics of its pores, and the separator according to an embodiment of the present disclosure may have an excellent advantage in achieving a low resistance value as the small pore size is controlled.

The separator according to an embodiment of the present disclosure may have a thickness of about 8 μm or less and exhibit an electrical resistance of about 1.0Ω or less.

The electrical resistance of the separator according to an embodiment of the present disclosure may be, for example, about 1.0Ω or less, 0.5Ω or less, 0.50Ω or less, 0.45Ω or less, or 0.40Ω or less. Alternatively, the electrical resistance of the separator may be about 0.01Ω to about 1.0Ω, about 0.05Ω to about 0.8Ω, about 0.10Ω to about 0.6Ω, about 0.20Ω to about 0.5Ω, about 0.25Ω to about 0.50Ω, about 0.30Ω to about 0.45Ω, about 0.35Ω to about 0.40Ω, or about 0.39Ω to about 0.40Ω, but the present disclosure is not limited thereto.

As used herein, the “electrical resistance” of the separator may be measured by a known method of measuring the resistance value of a separator, and is not particularly limited to the measurement method.

According to an embodiment of the present disclosure, the resistance of the separator may be measured by punching the separator into a size of 19 dD, stacking it in a CR2016 coin cell case, filling it with an electrolyte, and measuring it using EIS. As the EIS device, for example, a Solartron analytical EIS device of Solartron Co., or other commercially available devices may be used, but the present disclosure is not limited thereto.

In an embodiment of the present disclosure, the electrolyte for measuring the electrical resistance is not particularly limited as long as it has a composition that can be used in lithium secondary batteries. For example, the electrolyte may include a composition of 1M LiPF₆, ethylene carbonate (EC) and ethyl methyl carbonate (EMC) (3/7 v/v), and 2 wt % vinylene carbonate (VC), but the present disclosure is not limited thereto.

### Method of Manufacturing Separator

Hereinafter, a method of manufacturing a separator according to an aspect of the present disclosure will be described. However, the following manufacturing method is merely illustrative of the method of manufacturing the separator, and the method of manufacturing the separator is not limited thereto.

According to another aspect of the present disclosure, a method of manufacturing the separator is provided.

The method of manufacturing the separator according to another aspect of the present disclosure may adopt a wet process.

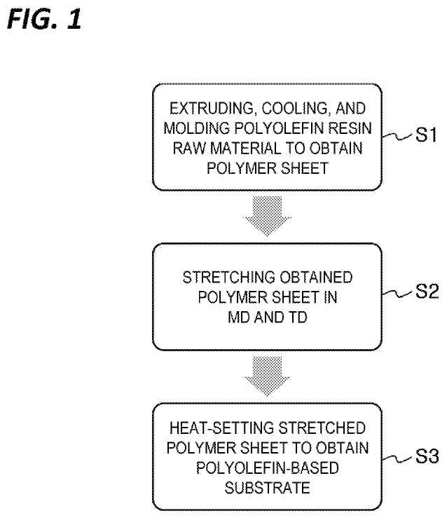

Referring to FIG. 1, a method of manufacturing the separator may include the steps of: (S1) extruding, cooling, and molding a polyolefin resin raw material to obtain a polymer sheet; (S2) stretching the obtained polymer sheet in MD and TD; and (S3) heat-setting the stretched polymer sheet to obtain a polyolefin-based substrate.

A method of manufacturing a separator according to an aspect of the present disclosure may manufacture the polyolefin-based substrate to have a thickness of about 8 μm or less.

In addition, the method of manufacturing a separator according to an aspect of the present disclosure may manufacture the polyolefin-based substrate to have a minimum pore size of about 20 nm or more.

According to an embodiment of the present disclosure, the polyolefin-based substrate is formed by using a polyolefin resin as a raw material and processing the polyolefin resin into a polymer sheet through a series of high-temperature extrusion, cooling, and stretching processes. At this time, the polymer sheet has a characteristic in which the properties of pores formed on its surface vary depending on the temperature and/or pressure applied during the manufacturing process. In order to manufacture a porous polymer substrate that is produced without damage to the polymer sheet during the above series of processes, a polyethylene resin may be included as the polyolefin resin. However, any polyolefin-based resin other than the polyethylene resin may be used without limitation.

In an embodiment of the present disclosure, the polyolefin resin may include, for example, one having a weight-average molecular weight (Mw) of about 500,000 g/mol to about 5,000,000 g/mol. For example, the weight-average molecular weight of the polyolefin resin may be about 500,000 g/mol to about 2,000,000 g/mol, about 500,000 g/mol to about 1,000,000 g/mol, about 500,000 g/mol to about 800,000 g/mol, about 500,000 g/mol to about 700,000 g/mol, or about 550,000 g/mol to about 650,000 g/mol. Alternatively, the weight-average molecular weight of the polyolefin resin may be, for example, about 600,000 g/mol, but the present disclosure is not limited thereto.

At this time, the weight-average molecular weight of the polymer may represent a value measured according to a measurement method of an embodiment, and may represent a value measured using, for example, a gel permeation chromatograph (GPC).

In this case, the GPC measurement conditions may be referred to the following conditions, but the present disclosure is not limited thereto.
Column: PL Olexis (Polymer Laboratories Co.)
Solvent: trichlorobenzene (TCB)
Flow rate: 1.0 ml/min
Sample concentration: 1.0 mg/ml
Injection volume: 200 μl
Column temperature: 160° C.
Detector: Agilent High Temperature RI detector
Standard: Polystyrene (calibrated by a cubic function)

The step (S1) is a step of extruding a raw material including the above-described polyolefin resin to obtain an extrudate, and cooling and molding the high-temperature extrudate to obtain a polymer sheet.

In an embodiment of the present disclosure, the extrusion may be performed by a process for extruding a polymer in the field of separator manufacturing. For example, as the extruder for the extrusion, a single-screw extruder or a twin-screw extruder may be used, but the present disclosure is not limited thereto.

In an embodiment of the present disclosure, the extrusion may be performed by introducing a polyolefin resin and a diluent into an extruder and melt-extruding the mixture at a temperature of, for example, about 170° C. to about 250° C., for example, at about 200° C.

In an embodiment of the present disclosure, the diluent may be used by using a diluent used in a separator manufacturing process for diluting raw materials. The diluent refers to a substance that is mixed with a polyolefin-based resin to form an extrudate, undergoes phase separation upon cooling, and is removed to form pores. The diluent is not particularly limited as long as it satisfies such a function. Non-limiting examples of such a diluent include: aliphatic hydrocarbon-based solvents such as paraffin oil; vegetable oils such as soybean oil; or plasticizers such as dialkyl phthalates, but the present disclosure is not limited thereto. Among these, liquid paraffin oil, which has excellent compatibility with polyolefin-based resins, for example, paraffin oil having a kinematic viscosity of 20 to 200 cSt at 40° C., may be suitably used. The diluent may be used alone or in the form of a mixture of two or more kinds.

In an embodiment of the present disclosure, the extruded melt may be discharged through a die, and at this time, the thickness of the polyolefin-based substrate to be manufactured may be controlled by adjusting the discharged amount.

In an embodiment of the present disclosure, the manufactured polyolefin-based substrate may be discharged so as to implement a thickness of about 8 μm or less.

Next, after obtaining the extrudate, the extrudate may be cooled to obtain a polymer pre-sheet.

According to an embodiment of the present disclosure, the obtained extrudate may be molded into a sheet form using a cooling casting device at a temperature of about 20° C. to about 60° C. For example, the extrudate discharged from the extrusion unit may be cooled and molded into a polymer sheet form by passing between a pair of cooling casting rolls at a running speed of 7 m/min at a temperature of 40° C.

The step (S2) is a step of stretching the obtained polymer sheet in a machine direction (MD) and a transverse direction (TD) perpendicular thereto, respectively.

In an embodiment of the present disclosure, the step (S2) may include a process of sequentially stretching the polymer pre-sheet in the machine direction and the transverse direction, and may include, for example, a process of stretching the sheet about 4 to about 10 times in the machine direction and about 4 to about 10 times in the transverse direction using a tenter-type stretcher.

In an embodiment of the present disclosure, a pore size formed in the polymer sheet may vary depending on the stretching ratio and/or temperature in the MD and TD stretching. Therefore, to ensure that the minimum pore size of the obtained polyolefin-based substrate is implemented to be about 20 nm or more, the MD and TD stretching ratio and/or temperature may be controlled as follows.

The method of manufacturing a separator according to an aspect of the present disclosure may include performing at least one of the MD stretching and TD stretching processes at a temperature of about 130° C. or higher. For example, at least one of the MD and TD stretching processes may be performed at a temperature of about 130° C. to about 145° C.

In an embodiment of the present disclosure, the stretching step may include sequentially performing the MD stretching and the TD stretching, in which the TD stretching is performed after the MD stretching.

At this time, according to an embodiment of the present disclosure, the subsequent TD stretching step may be performed at a temperature of about 130° C. to about 145° C., but the present disclosure is not limited thereto.

According to an embodiment of the present disclosure, the stretching step may include stretching in the MD direction followed by stretching in the TD direction, and the MD stretching may be performed at a temperature of about 110° C. to about 125° C., and the TD stretching may be performed at a temperature of about 130° C. to about 140° C., but the present disclosure is not limited thereto.

In an embodiment of the present disclosure, the MD stretching may be performed at a temperature of 125° C. or lower, for example, about 110° C. to about 125° C., about 110° C. to about 120° C., about 110° C. to about 115° C., or about 110° C. to about 112° C., in consideration of the melting temperature of the polyolefin-based resin. When the MD stretching temperature becomes too high, the maximum pore diameter of the obtained polyolefin-based substrate may become too small due to proximity to the melting point of the polyolefin resin, and thus a problem may arise in which the intrinsic porosity of the separator may not be secured.

In an embodiment of the present disclosure, the MD stretching may be performed at a stretching ratio of about 4 to about 10 times, 6 to 9 times, about 6 to 8 times, about 6 to 7 times, about 6.0 to about 6.5 times, about 6.0 to about 6.3 times, or about 6.0 to about 6.1 times, but the present disclosure is not limited thereto.

In an embodiment of the present disclosure, the MD stretching may be performed at a temperature of about 110° C. to about 115° C. at a stretching ratio of about 6.0 to about 6.5 times, but the present disclosure is not limited thereto.

In an embodiment of the present disclosure, the TD stretching may be sequentially performed after the MD stretching. At this time, as the degree of crystallinity of the polymer sheet increases through the MD stretching, the TD stretching may be performed at a temperature within a predetermined range higher than the MD stretching. For example, the TD stretching may be performed at a temperature higher than the MD stretching temperature by about 5° C. or more, about 10° C. or more, about 15° C. or more, about 20° C. or more, or about 5° C. to 20° C., about 10° C. to about 20° C., about 15° C. to about 20° C., or about 19° C. to about 21° C. For example, the TD stretching may be performed at a temperature of about 130° C. to about 135° C. or about 131° C. to about 133° C., but the present disclosure is not limited thereto.

In an embodiment of the present disclosure, the TD stretching may be performed at a stretching ratio of about 6 times to about 10 times, about 7 times to about 10 times, about 8 times to about 10 times, about 8 times to about 9 times, about 8 times to about 8.5 times, or about 8.0 times to about 8.1 times, but the present disclosure is not limited thereto.

In an embodiment of the present disclosure, the TD stretching may be performed at a temperature of about 130° C. to about 140° C. or about 130° C. to about 135° C. at a stretching ratio of about 8.0 times to about 8.5 times, about 8.0 times to about 8.2 times, or about 8.0 times to about 8.1 times, but the present disclosure is not limited thereto.

In an embodiment of the present disclosure, after the MD and TD stretching of the polymer sheet, a process of removing the diluent used in the preceding process may be further performed.

In an embodiment of the present disclosure, a process of extracting and removing the diluent may be performed using an appropriate solvent for the removal of the diluent. The solvent usable for removing the diluent is not particularly limited, and any solvent capable of extracting the diluent used in the extrusion step may be used. For example, methyl ethyl ketone, methylene chloride, or hexane, which exhibits high extraction efficiency and fast drying, may be used. Methylene chloride may be used, as an example. The extraction method may use any general solvent extraction method, such as an immersion method, a solvent spray method, or an ultrasonic method, either individually or in combination.

In an embodiment of the present disclosure, the amount of the diluent remaining in the polymer sheet after the extraction of the diluent may be about 1 wt % or less, based on the total weight of the polymer sheet. When the residual diluent exceeds about 1 wt %, there may be a problem in that the physical properties deteriorate and the permeability of the membrane decreases, but the present disclosure is not limited thereto.

The step (S3) serves to reduce thermal shrinkage properties by holding the polymer sheet in which pores are formed through removal of the diluent in the MD and/or the TD and applying heat, and may be performed according to a method of an embodiment.

According to an embodiment of the present disclosure, the heat-setting temperature may be performed at a temperature within about 5° C. of the TD temperature. For example, the heat-setting temperature may be performed at a temperature within about 1° C. to about 2° C. of the TD temperature, which may be effective in terms of controlling the minimum pore size, but the present disclosure is not limited thereto.

In an embodiment of the present disclosure, the heat-setting may be performed at a temperature of about 125° C. to about 140° C., about 130° C. to about 135° C., or about 131° C. to about 132° C., but the present disclosure is not limited thereto.

In this way, according to an embodiment of the present disclosure, the polyolefin-based substrate obtained as described above may include only pores, which are empty spaces between polyolefin fibers and polyolefin. Thus, according to an aspect of the present disclosure, a polyolefin-based substrate having a thickness of about 8 μm or less and a minimum pore size of about 20 nm or more may be obtained.

In an embodiment of the present disclosure, the polyolefin-based substrate obtained as described above itself may be used as a separator.

In another embodiment of the present disclosure, by further performing the step of forming a binder adhesive layer and/or a heat-resistant coating layer on at least one surface of the polyolefin-based substrate obtained as described above, a separator provided with a binder adhesive layer and/or a heat-resistant coating layer on at least one surface of the polyolefin-based substrate may be obtained.

### Electrode Assembly

According to another aspect of the present disclosure, an electrode assembly including the above-described separator and a positive electrode and a negative electrode that are formed on respective opposite surfaces of the separator is provided.

As described above, the separator according to an aspect of the present disclosure has a thin thickness and achieves a low resistance value. Accordingly, when charge/discharge cycles are performed in an electrochemical device using the separator, excellent output characteristics may be achieved due to the low resistance of the separator. Furthermore, by implementing a separator having a thin thickness and a minimum pore size of 20 nm or more, the amount of lithium plated into the pores of the separator during charge/discharge cycles of the electrochemical device may be significantly reduced, and thus the electrochemical device may exhibit excellent capacity retention characteristics during the charge/discharge cycling.

Hereinafter, the configuration of the electrode will be described by way of example. However, the present disclosure is not limited thereto.

In an embodiment of the present disclosure, the positive electrode and the negative electrode may each be formed by coating an electrode active material on a current collector, and the size, shape, and type of the active material are not particularly limited.

In an embodiment of the present disclosure, a positive electrode and a negative electrode may be used to verify the capacity retention of the electrochemical device using the separator, and the types of the electrodes are not particularly limited.

For example, the electrode assembly may include, as a positive electrode active material: lithium transition metal oxides; lithium metal iron phosphates; lithium nickel-manganese-cobalt oxides; lithium nickel-manganese-cobalt oxides in which a portion is substituted with another transition metal; or two or more thereof, but is not limited thereto. For example, the positive electrode active material may include: a layered compound such as lithium cobalt oxide (LiCoO₂), lithium nickel oxide (LiNiO₂), or a compound substituted with one or more transition metals; a lithium manganese oxide such as Li₁₊ₓMn₂₋ₓO₄ (where x=0 to 0.33), LiMnO₃, LiMn₂O₃, or LiMnO₂; lithium copper oxide (Li₂CuO₂); a vanadium oxide such as LiV₃O₈, LiV₃O₄, V₂O₅, or Cu₂V₂O₇; a Ni-site lithium nickel oxide represented by the chemical formula LiNi₁₋ₓMₓO₂ (where M=Co, Mn, Al, Cu, Fe, Mg, B, or Ga, and x=0.01 to 0.3); a lithium manganese composite oxide represented by the chemical formula LiMn₂₋ₓMₓO₂ (where M=Co, Ni, Fe, Cr, Zn, or Ta, and x=0.01 to 0.1) or Li₂Mn₃MOs (where M=Fe, Co, Ni, Cu, or Zn); a lithium metal phosphate represented by the chemical formula LiMPO₄ (where M=Fe, Co, Ni, or Mn); a lithium nickel-manganese-cobalt oxide represented by the chemical formula Li₁₊ₓ(NiₐCo_{b}Mn_{c})₁₋ₓO₂ (x=0 to 0.03, a=0.3 to 0.95, b=0.01 to 0.35, c=0.01 to 0.5, and a+b+c=1); a lithium nickel-manganese-cobalt oxide partially substituted with aluminum and represented by the chemical formula Liₐ[Ni_{b}Co_{c}Mn_{d}Alₑ]_{1-f}M1_{f}O₂ (M1 is at least one selected from Zr, B, W, Mg, Ce, Hf, Ta, La, Ti, Sr, Ba, F, P, and S, 0.8≤a≤1.2, 0.5≤b≤0.99, 0<c<0.5, 0<d<0.5, 0.01≤e≤0.1, and 0≤f≤0.1); a lithium nickel-manganese-cobalt oxide partially substituted with another transition metal and represented by the chemical formula Li₁₊ₓ(NiₐCo_{b}Mn_{c}M_{d})₁₋ₓO₂ (x=0 to 0.03, a=0.3 to 0.95, b=0.01 to 0.35, c=0.01 to 0.5, d=0.001 to 0.03, a+b+c+d=1, and M is one selected from Fe, V, Cr, Ti, W, Ta, Mg, and Mo); a disulfide compound; or Fe₂(MoO₄)₃, but is not limited thereto.

In an embodiment of the present disclosure, the electrode assembly may include, as a negative electrode active material: carbon such as non-graphitizable carbon or graphitic carbon; a metal composite oxide such as LiₓFe₂O₃ (0≤x≤1), LiₓWO₂ (0≤x≤1), or SnₓMe₁₋ₓMe′_{y}O_{z} (where Me is Mn, Fe, Pb, or Ge; Me′ is Al, B, P, Si, a Group 1, 2, or 3 element of the periodic table, or a halogen; 0<x≤1; 1≤y≤3; 1≤z≤8); lithium metal; a lithium alloy; a silicon-based alloy; a tin-based alloy; a silicon-based oxide such as SiO, SiO/C, or SiO₂; a metal oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, or Bi₂O₅; a conductive polymer such as polyacetylene; or a Li—Co—Ni-based material, but is not limited thereto.

In an embodiment of the present disclosure, the positive electrode may be prepared, for example, by the following method. First, a positive electrode active material (LiNi_{0.8}Mn_{0.1}Co_{0.1}O₂), a conductive material (carbon black), a dispersant, and a binder resin (PVDF) are mixed with water in a weight ratio of about 97.5:0.7:0.2:1.6 to prepare a positive electrode active material layer slurry with a concentration of 50 wt % of the components other than water. Next, the slurry is applied to the surface of an aluminum thin film (e.g., with a thickness of 10 μm) and dried to manufacture a positive electrode having a positive electrode active material layer (e.g., with a thickness of 60 μm). The above-described method of manufacturing a positive electrode is merely an example and is not intended to limit the present disclosure.

In an embodiment of the present disclosure, the negative electrode may be prepared, by way of example, as follows. First, artificial graphite, carbon black, carboxymethyl cellulose (CMC), and a binder resin (SBR) is mixed with water in a weight ratio of about 97.5:0.7:1.1:0.7 to prepare a negative electrode active material layer slurry with a concentration of about 50 wt % of the components other than water. Next, the slurry is applied to the surface of a copper thin film (e.g., with a thickness of 10 μm) and dried to manufacture a negative electrode having a negative electrode active material layer (e.g., with a thickness of 60 μm). The above-described method of manufacturing a negative electrode is merely an example and is not intended to limit the present disclosure.

In an embodiment of the present disclosure, by controlling the minimum pore size, the separator may achieve an effect of reducing the damage rate of fine pores when the negative electrode, the separator, and the positive electrode are sequentially stacked and then laminated through heating and/or pressing. According to an embodiment of the present disclosure, in order to compare the degree of damage to the fine pores during lamination of the separator and the electrodes, a method of testing the insulation of the electrode assembly using a known Hi-pot tester may be used after sequentially stacking the negative electrode, the separator, and the positive electrode. For example, after preparing at least 20 samples of the electrode assembly, the lamination stability of the separator and the electrodes depending on the control of the fine pore size may be measured by applying a current under the conditions of 50 V and <0.5 mA (charge time: 50 ms, test time: 50 ms) using a Hi-pot tester (Chroma Co., Model 19052) and checking whether dielectric breakdown occurs.

In an embodiment of the present disclosure, the method of laminating the laminate of the negative electrode/separator/positive electrode or the positive electrode/separator/negative electrode may use, for example, a hot-press process.

For example, the hot-press may be performed to bond the positive electrode/separator/negative electrode laminate by applying temperature and pressure to the laminate using a hot-press machine.

In an embodiment of the present disclosure, the hot-press may be performed, for example, at a temperature of about 55° C. to about 75° C., about 55° C. to about 70° C., about 60° C. to about 65° C., or about 60° C., but the present disclosure is not limited thereto.

In an embodiment of the present disclosure, the hot-press may be performed, for example, at a pressure of about 5 MPa to about 8 MPa, about 5 MPa to about 7 MPa, about 6 MPa to about 6.5 MPa, or about 6.0 MPa to about 6.5 MPa, but the present disclosure is not limited thereto.

In an embodiment of the present disclosure, the hot-press may be performed under conditions of 60° C. and 6.5 MPa, but the present disclosure is not limited thereto.

### Electrochemical Device

According to another aspect of the present disclosure, an electrochemical device in which the above-described electrode assembly is accommodated in a case may be provided.

In an embodiment of the present disclosure, the electrochemical device may be, for example, a primary battery, a secondary battery, a super capacitor, or an electric double layer capacitor. The secondary battery may be a lithium-ion secondary battery.

In an embodiment of the present disclosure, the case is a battery case, and the external shape of the case is not particularly limited depending on the use of the battery. For example, the case may be cylindrical, prismatic, pouch-type, or coin-type using a can. In an embodiment of the present disclosure, the electrochemical device may further include an electrolyte injected into a case, and the electrolyte may be used without particular limitation as long as it is a conventional electrolyte commonly used in implementing an electrochemical device.

When the electrode assembly as described above is completed, it may be accommodated in the case and sealed to manufacture an electrochemical device. In this case, the electrochemical device may be, for example, a lithium secondary battery.

According to an embodiment of the present disclosure, by using the above-described separator, the electrochemical device may exhibit an excellent capacity retention effect because lithium plating on the surface and/or inside the pores of the separator caused by charge/discharge cycles is suppressed.

According to an embodiment of the present disclosure, the electrochemical device may achieve a capacity retention of about 90% or more according to Equation 1 below.

$$Capacity Retention ( \% ) = ( {C}_{n + 200} ) / {C}_{n} ) \times 100 ( \% ) \qquad [ Equation 1 ]$$

$$( n is an integer of 1 or more )$$

In an embodiment of the present disclosure, n in Equation 1 is an integer of 1 or more. For example, n may be an integer from 1 to 1,000, from 1 to 800, from 1 to 600, or from 1 to 500, but the present disclosure is not limited thereto.

In an embodiment of the present disclosure, when n is 1, the capacity retention may be, for example, about 90% or more, about 92% or more, about 94% or more, or about 95% or more. In an embodiment, the capacity retention of the electrochemical device may be in the range of about 94% to about 95%, but the present disclosure is not limited thereto.

As used herein, the capacity retention of the electrochemical device according to charge/discharge cycles may be measured by obtaining a cycle-discharge capacity graph through charging at a 1 C rate and discharging at a 1 C rate (CC/CC) within a voltage range of 2.5 V to 4.2 V at room temperature (25° C.), but the present disclosure is not limited thereto.

Hereinafter, the present disclosure will be described in more detail through examples, but the following examples are merely provided to illustrate the present disclosure, and the scope of the present disclosure is not limited thereto.

### [Manufacture of Polyolefin Substrate]

### Example 1

Into an extruder (Korea EM, φ32 twin-screw extruder, L/D=56) were fed 9 kg of high-density polyethylene (HDPE) (Daehan Petrochemical, VH035) and 21 kg of a diluent (Kukdong Petrochemical, LP350F), and followed by melt-extrusion at 200° C. to obtain a polyethylene melt extrudate. The obtained melt extrudate was passed through a T-die, and then cooled and molded into a sheet form using a cooling casting device at a running speed of 7 m/min at a temperature of 40° C. Subsequently, the extrudate was subjected to MD stretching (112° C., stretching ratio 6.0) followed by TD stretching (130° C., stretching ratio 8.0) using a tenter-type sequential stretcher. From the stretched polyolefin, a porous film was formed by extracting the diluent using methylene chloride, and then heat-set at a temperature of 132° C. (stretching ratio 1.2) to obtain a polyolefin substrate having a thickness of 7 μm.

### Example 2

A polyolefin substrate having a thickness of 7 μm was obtained in the same manner as in Example 1, except that the MD stretching ratio was changed to 6.1 times and the TD stretching was performed at 133° C.

### Example 3

A polyolefin substrate having a thickness of 7 μm was obtained in the same manner as in Example 1, except that the MD stretching ratio was changed to 5.8 times and the TD stretching was performed at 136° C. at a stretching ratio of 8.2 times.

### Comparative Example 1

A polyolefin substrate having a thickness of 7 μm was obtained in the same manner as in Example 1, except that the MD stretching ratio was changed to 5.8 times, the TD stretching was performed at 128° C. at a stretching ratio of 7.6 times, and the heat-setting was performed at 133° C.

### Comparative Example 2

A polyolefin substrate was obtained in the same manner as in Example 1, except that the extrusion amounts were changed to 11.5 kg of high-density polyethylene (HDPE) (Daehan Petrochemical, VH035) and 27 kg of diluent (Kukdong Oil & Chem, LP350F). At this time, the thickness of the obtained polyolefin substrate was 9 μm.

### [Evaluation of Physical Properties of Polyolefin Substrate]

### Measurement of Minimum Pore Size (Nm)

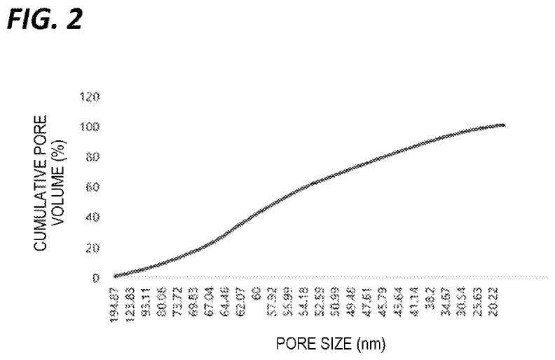

Referring to FIG. 2, the minimum pore size of the polyolefin substrate manufactured as described above was measured using an Aqua Pore instrument (WMI-5K, Poretech Instrument Co.) employing the water intrusion method. Water was infiltrated into the polyolefin substrate under a pressure of 150 psi to 1,800 psi until the pores of the polyolefin substrate reached a saturated state (100 vol %), and a graph of cumulative pore volume as a function of pore size (nm) was obtained. In the graph, the pore size (nm) at which water infiltrated at 99 vol % in the later stage was measured as the minimum pore size.

### Measurement of Electrical Resistance of Separator

A coin cell was fabricated by the following method, and the resistance of the separator was measured using the EIS method. The EIS measurement was performed using a Solartron analytical EIS instrument (Solartron Co.), and the resistance value was measured under conditions of a frequency range of 100,000 to 10,000 Hz.

The coin cell was prepared as follows. The polyolefin substrate prepared as described above was die-cut to 19Φ to prepare a separator. An electrolyte having a composition of 1M LiPF₆, ethylene carbonate (EC) and ethyl methyl carbonate (EMC) (3/7 v/v), and 2 wt % vinylene carbonate (VC) was injected into the CR2016 coin cell case along with the separator, and the case was sealed with a cap to prepare the coin cell.

### Measurement of Breakdown Voltage (V)

The measurement was carried out using an AC/DC/IR Hi-pot tester (Chroma Co., Model 19052). Specifically, a prepared separator sample was placed between an upper aluminum jig (diameter: 30 mm) and a lower aluminum jig (diameter: 50 mm), and the voltage at which a fail condition (>0.5 mA for 3 seconds) occurred was measured using a Hi-pot tester.

At this time, the measurement conditions were set to DC, current 0.5 mA, and voltage ramping 100 V/s (up to 3 kV). The measured value was represented as the average value of 30 samples.

### Measurement of Capacity Retention

A pouch-type mono cell was prepared by the following method, and the capacity retention was measured.

### 1) Manufacture of Positive Electrode

A positive electrode active material (LiNi_{0.8}Mn_{0.1}Co_{0.1}O₂), a conductive material (carbon black), a dispersant, and a binder resin (PVDF) were mixed with water in a weight ratio of 97.5:0.7:0.2:1.6 to prepare a positive electrode active material layer slurry with a concentration of 50 wt % of the components other than water. Next, the slurry was applied to the surface of an aluminum thin film (thickness: 10 μm) and dried to manufacture a positive electrode having a positive electrode active material layer (thickness: 60 μm).

### 2) Manufacture of Negative Electrode

Artificial graphite, carbon black, carboxymethyl cellulose (CMC), and a binder resin (SBR) were mixed with water in a weight ratio of 97.5:0.7:1.1:0.7 to prepare a negative electrode active material layer slurry with a concentration of 50 wt % of the components other than water. Next, the slurry was applied to the surface of a copper thin film (thickness: 10 μm) and dried to manufacture a negative electrode having a negative electrode active material layer (thickness: 60 μm).

### 3) Pouch Cell Assembly

The positive electrode, the polyolefin substrate, and the negative electrode manufactured as described above were sequentially stacked and inserted into an aluminum pouch. Then, an electrolyte having a composition of 1M LiPF₆, ethylene carbonate (EC) and ethyl methyl carbonate (EMC) (3/7 v/v), and 2 wt % vinylene carbonate (VC) was injected into the pouch to prepare a pouch-type mono cell.

The pouch-type mono cell prepared as described above was subjected to charge/discharge cycles in the following manner, and the discharge capacity after 200 cycles was evaluated based on the first discharge capacity to measure the capacity retention (%) over 200 cycles.

The charge/discharge cycles were performed at room temperature (25° C.) within a voltage range of 2.5 V to 4.2 V, using 1 C rate charging and 1 C rate discharging (CC/CC) as one cycle.

TABLE 1

| | Minimum | Electrical | Breakdown | Capacity |
|---|---|---|---|---|
| | pore size | resistance | Voltage | retention |
| | (nm) | (O) | (V) | (%) |
| Example 1 | 22 | 0.4 | 1,100 | 94.5 |
| Example 2 | 24 | 0.39 | 1,065 | 95.0 |
| Example 3 | 32 | 0.35 | 860 | 95.0 |
| Comparative | 18 | 0.43 | 1,150 | 86.0 |
| Example 1 | | | | |
| Comparative | 23 | 0.60 | 1,300 | 94.0 |
| Example 2 | | | | |

As indicated in the results of Table 1, when the minimum pore size is less than 20 nm, the electrical resistance of the separator increases, and when used for battery manufacturing, the capacity retention of the battery decreases as the charge/discharge cycles are repeated. For example, in Examples 1, 2, and 3, the minimum pore size is 20 nm or more, and the capacity retention rates are 94.5%, 95%, and 95%, respectively. In contrast, in Comparative Example 1, the minimum pore size is 18 nm, which is smaller than 20 nm, and the electrical resistance is relatively higher than those of Examples 1, 2, and 3, while the capacity retention is relatively lower at 86%.

Meanwhile, in the case of Comparative Example 2, although the minimum pore size of the polyolefin-based substrate satisfies 20 nm or more, the electrical resistance was confirmed to increase by about 50% compared to Example 1 as the thickness increased to 9 μm.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A separator comprising:
a polyolefin-based substrate having a thickness of about 8 μm or less,
wherein the polyolefin-based substrate has a minimum pore size of about 20 nm or more.

2. The separator according to claim 1, wherein the minimum pore size is measured by a method of measuring the pore size when the water saturation degree is 99 vol % based on 100 vol % water saturation when water is infiltrated into the polyolefin-based substrate under a constant pressure.

3. The separator according to claim 1, wherein the polyolefin-based substrate has a thickness of about 5 μm to about 8 μm.

4. The separator according to claim 1, wherein the minimum pore size of the polyolefin-based substrate is about 20 nm to about 30 nm.

5. The separator according to claim 1, wherein the electrical resistance of the separator is about 0.40Ω or less.

6. The separator according to claim 1, comprising:
at least one layer selected from a heat-resistant coating layer and a binder adhesive layer on at least one surface of the polyolefin-based substrate.

7. A separator manufacturing method comprising:
obtaining a polymer sheet by extruding, cooling, and molding a polyolefin resin raw material;
stretching the obtained polymer sheet in MD and TD; and
obtaining a polyolefin-based substrate by heat-setting the stretched polymer sheet,
wherein at least one of the MD stretching and the TD stretching is performed at a temperature of about 130° C. to about 145° C., and
the polyolefin-based substrate has a thickness of about 8 μm or less.

8. The separator manufacturing method according to claim 7, wherein the stretching includes stretching in the MD direction followed by stretching in the TD direction,
the MD stretching is performed at a temperature of about 110° C. to about 125° C., and
the TD stretching is performed at a temperature of about 130° C. to about 140° C.

9. The separator manufacturing method according to claim 7, wherein the TD stretching is performed at a stretching ratio of 8 to 10 times.

10. The separator manufacturing method according to claim 7, wherein the minimum pore size of the polyolefin-based substrate is about 20 nm or more.

11. An electrode assembly comprising:
the separator according to claim 1; and
a positive electrode and a negative electrode provided on respective opposite surfaces of the separator.

12. An electrochemical device comprising:
the electrode assembly according to claim 11; and
a case accommodating the electrode assembly.

13. The electrochemical device according to claim 12, wherein the electrochemical device may exhibit a capacity retention of 90% or more according to Equation 1 below.
Capacity Retention (%)=(Cₙ₊₂₀₀/Cₙ)×100(%) (where n is an integer of 1 or more) [Equation 1]

14. The separator manufacturing method according to claim 7, further comprising:
removing the diluent after the step of stretching in the MD and TD.

15. The separator manufacturing method according to claim 14, wherein the amount of the diluent remaining in the polymer sheet after the extraction of the diluent is about 1 wt % or less based on the total weight of the polymer sheet.
